(19) United States
(12) Patent Application Publication
(10) Pub. No.: US 2009/0267868 A1
(43) Pub. Date: Oct. 29, 2009

(54) DISPLAY DEVICE

(75) Inventors: Tomoo Takatani, Nara-shi (JP); Koji Yabuta, Kashiba-shi (JP); Hiroshi Fukushima, Yamatokoriyama-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: Sharp Kabushiki Kaisha, Osaka-shi, Osaka (JP)

(21) Appl. No.: 11/817,887

(22) PCT Filed: Mar. 2, 2006
(86) PCT No.: PCT/JP2006/304005

§ 371 Date: Sep. 6, 2007

(30) Foreign Application Priority Data
Mar. 7, 2005 (JP) 2005-063173

(51) Int. Cl. G09G 5/12; G09G 3/32

(52) U.S. Cl. 345/1.3; 345/82

(57) ABSTRACT

A display device includes a display screen including (i) a normal display area for normal display, and (ii) a DV display area for a DV display area. Pixel columns corresponding to the DV display area are provided in a fixed order in accordance with directions in which images are respectively displayed. Further, a barrier section is provided only for the DV display area so as to shield light, coming from the pixel columns corresponding to the DV display area, such that the images cannot be observed in a direction other than the display directions of the pixel columns. This makes it possible to provide a display device including a display screen provided with (i) a display area suitable for the normal display, and (ii) a display area allowing for the DV display.

### BACKGROUND OF THE INVENTION

1. Field of the Invention

The present invention relates to a display device having a display screen including (i) a display area (DV display area, identical-location plural-image display area) allowing different images to be displayed in a plurality of directions respectively and (ii) a display area (normal display area) allowing an identical image to be displayed in every direction.

2. Description of the Related Art

Conventionally, there has been proposed a display device capable of displaying different images on a display screen in a plurality of directions respectively (DV (dual view) display, identical-location plural-image display).

FIG. 6 is a cross sectional view illustrating an example of the configuration of such a display device. The display device shown in FIG. 6 includes a barrier section 120, an adhesive resin layer 140, a display panel 110, and a backlight 130.

The backlight 130 emits light to the display panel 110. FIG. 7 is a plan view schematically illustrating the configuration of the backlight 130. As shown in FIG. 7, the backlight 130 includes a light source 131 and a reflecting section 132. The light source 131 is constituted by, e.g., a cold cathode fluorescent tube (CCFT), a cold cathode fluorescent lump (CCFL), or the like, and is provided so as to surround the reflecting section 132. The reflecting section 132 reflects, toward the display panel 110, light coming from the light source 131, thereby allowing uniform luminance distribution (e.g., 20000 cd/cm2) in the display plane of the display panel 110.

As shown in FIG. 6, the display panel 110 is an active matrix type liquid crystal display panel in which a liquid crystal layer 114 is interposed between a TFT substrate 111 and a CF substrate 112 provided face to face to each other.

Provided on the TFT substrate 111 are a plurality of data signal lines (not shown) and a plurality of scan signal lines (not shown) crossing with the data signal lines. For combinations of these data signal lines and scan signal lines, pixels are provided respectively. Further, the data signal lines are connected to a source driver (not shown), and the scan signal lines are connected to a gate driver (not shown). This makes it possible to independently apply driving voltages to the pixels so as to change orientation states of liquid crystal molecules of each pixel region in the liquid crystal layer 114. In this way, a display operation is carried out.

The CF (color filter) substrate 112 includes a color filter layer 113. FIG. 8 is a plan view schematically illustrating the configuration of the CF substrate 112. See FIG. 8. Provided on the CF substrate 112 is a color filter layer 113 including a multiplicity of pixels each made up of sub pixels of colors of R (red), G (green), B (blue). Further, pixel columns (lines of pixels in the vertical direction) are disposed in such a manner that pixel columns for the left side (display for the left side with respect to the display device) and pixel columns for the right side (display for the right side with respect to the display device) alternate with each other in the horizontal direction of FIG. 8. Note that, in the example shown in FIG. 8, the sub pixels are provided at a horizontal pitch of 65 μm. Accordingly, a horizontal pixel pitch Pₚ is: Pₚ=65 μm×3=195 μm.

The adhesive resin layer 140 is an adhesive layer for bonding the display panel 110 with the barrier section 120, and is made of a transparent material.

The barrier section 120 includes a barrier glass 121, barrier light shielding layers 122, and a resin layer 123. The barrier light shielding layers 122 shield a part of light emitted from the backlight 130 and having passed through the display panel 110. The resin layer 123 is provided on the barrier glass 121 so as to surround the barrier light shielding layers 122 such that a plane formed above the barrier glass 121 becomes flat.

FIG. 9 is a plan view schematically illustrating the configuration of the barrier section 120. As shown in FIG. 9, on a surface of the barrier section 120, the barrier light shielding layers 122 are formed in the form of lines so as to extend in the vertical direction. Note that, in the example shown in FIG. 9, a pitch (barrier pitch P_{b}) of the barrier light shielding layers 122 is set as follows: P_{b}=129.99 μm.

Further, the barrier light shielding layers 122 are provided so as to correspond to the pixel columns, respectively. In other words, each of the barrier light shielding layers 122 is provided so as to shield a part of light emitted from the backlight 130 and having passed through each of the pixel columns, with the result that the pixel columns for the left side are viewable from the left side with respect to the display device but are not viewable from the right side, and the pixel columns for the right side are viewable from the right side with respect to the display device but are not viewable from the left side. This allows the display device to display (DV display) different images for the left side and the right side, respectively.

As an alternative example, Patent Document 1 (Japanese Unexamined Patent Publication Tokukaihei 7-105484, published on Apr. 24, 1995) describes a vehicle-use information display device in which images for a driver's left eye and right eye and images for an assistant driver's (one in the passenger seat) left eye and right eye are arranged alternately based on a pixel as a unit. With this, the images for the driver's left eye and right eye and the images for the assistant driver's left eye and right eye are combined, with the result that a stereo image can be viewed from each of the driver seat and the passenger seat.

Patent Document 1 also describes that while the vehicle is moving, the images for the driver's left eye and right eye are caused to be blank and are combined with the images for the assistant driver's left eye and right eye, so that the stereo image is not viewable from the driver seat but is viewable from the passenger seat.

In each of such conventional display devices allowing for the DV display, the entire display screen is formed for the DV display. Hence, the conventional display device is not suitable for the following use: an image is displayed on a part of the display screen such that the image thereon looks the same when viewed in any direction, and DV display is carried out in the other areas on the display screen.

A conceivable example of such a use is as follows. That is, the conventional display device is used for an instrument panel of an automobile, an image such as a speedometer is displayed on the right half (viewed from an observer side) of its display screen such that the image is viewed from both the driver seat and the passenger seat, and different images are displayed on the left half of display screen such that one image is observed only from the driver seat and the other is observed only from the passenger seat.

Such a display device using a barrier layer for the DV display has characteristics that the display device has a resolution lower than that of a normal display use display device including no barrier layer.

Specifically, in the normal display use display device carrying out no DV display, all the pixels of its display panel can be observed when viewed in any observation direction; however, in the display device for DV display, only a part of all the pixels can be observed when viewed in an observation direction. For example, in the display device that displays different images for the driver seat side and the passenger seat respectively, the pixel columns for the driver seat side (half of all the pixels) are only observed from the driver seat side and the pixel columns for the passenger seat side (half of all the pixels) are only observed from the passenger seat side. Accordingly, the display device for DV display has a resolution lower than the normal display use display device that uses a display panel having the same resolution as the resolution of the display panel of the display device for DV display and that does not include any barrier layer. For this reason, the conventional display device carrying out DV display is unsuitable for normal display.

### SUMMARY OF THE INVENTION

In order to overcome the problems described above, preferred embodiments of the present invention provide a display device having a display screen provided with (i) a display area suitable for normal display, and (ii) a display area allowing for DV display.

A display device according to a preferred embodiment of the present invention includes a display screen provided with a plurality of display areas on which different images are able to be displayed, a portion of the plurality of display areas being an identical-location plural-image display area on which different images are able to be displayed in a plurality of display directions respectively, among the plurality of display areas, a display area other than the identical-location plural-image display area being a normal display area for displaying an image such that the image looks substantially same when viewed in every display direction.

According to the above configuration, different images are displayed on the identical-location plural-image display area in a plurality of display directions, respectively, and one image can be displayed on the normal display area in every display direction. This makes it possible to carry out high quality display as compared with a case where one image is displayed in every display direction on a part of the display screen that is provided in the conventional DV display use display device and is constituted only by the identical-location plural-image display area.

These and additional elements, features, characteristics, advantages and strengths of the present invention will be made clear by the description of preferred embodiments thereof below. Further, the advantages of preferred embodiments of the present invention will be evident from the following explanation in reference to the drawings.

### BRIEF DESCRIPTION OF THE DRAWINGS

FIG. 1 is a cross sectional view schematically illustrating the configuration of a display device according to a preferred embodiment of the present invention.

FIG. 2 is a plan view schematically illustrating the configuration of a backlight provided in the display device according to a preferred embodiment of the present invention.

FIG. 3 is a plan view schematically illustrating the configuration of a CF substrate provided in the display device according to a preferred embodiment of the present invention.

FIG. 4 is a plan view schematically illustrating the configuration of a barrier section in the display device according to a preferred embodiment of the present invention.

FIG. 5 is a block diagram illustrating an example of the configuration of the display device according to a preferred embodiment of the present invention, which configuration allows luminance in a normal display area and a DV display area to be variable.

FIG. 6 is a cross sectional view illustrating a conventional display device.

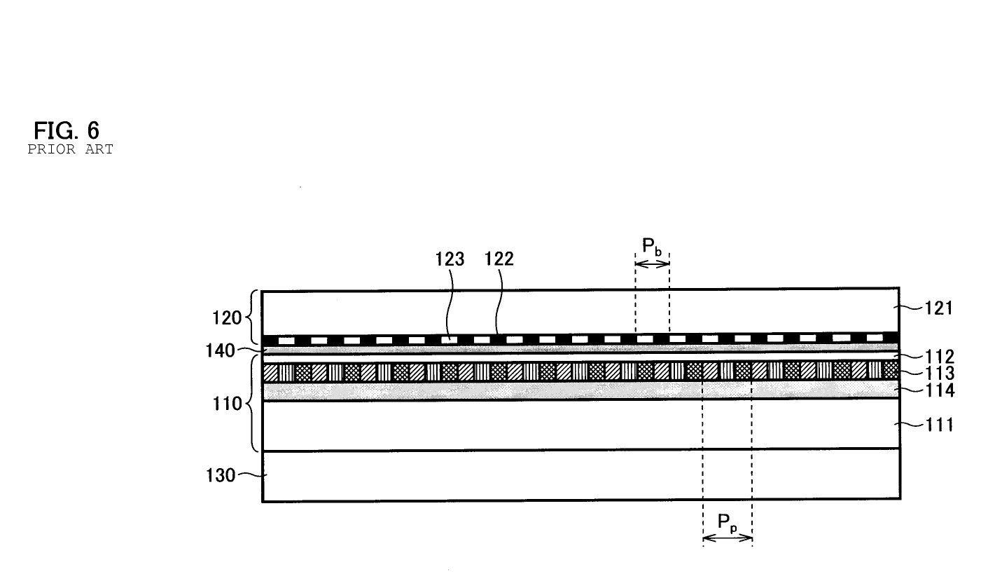

FIG. 7 is a plan view illustrating a backlight provided in the conventional display device.

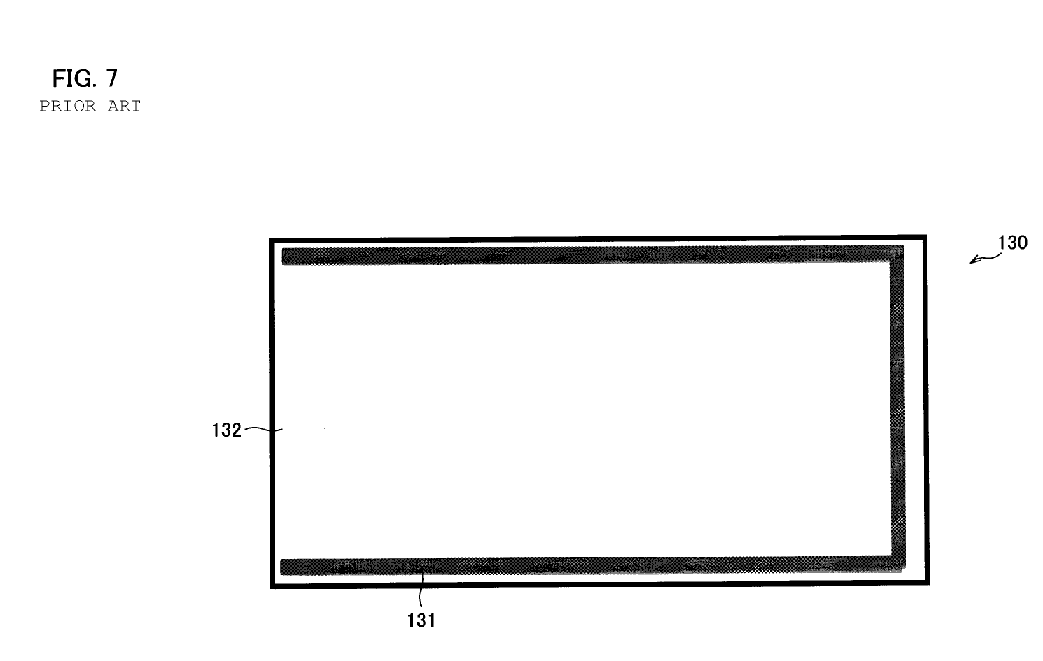

FIG. 8 is a plan view illustrating a CF substrate provided in the conventional display device.

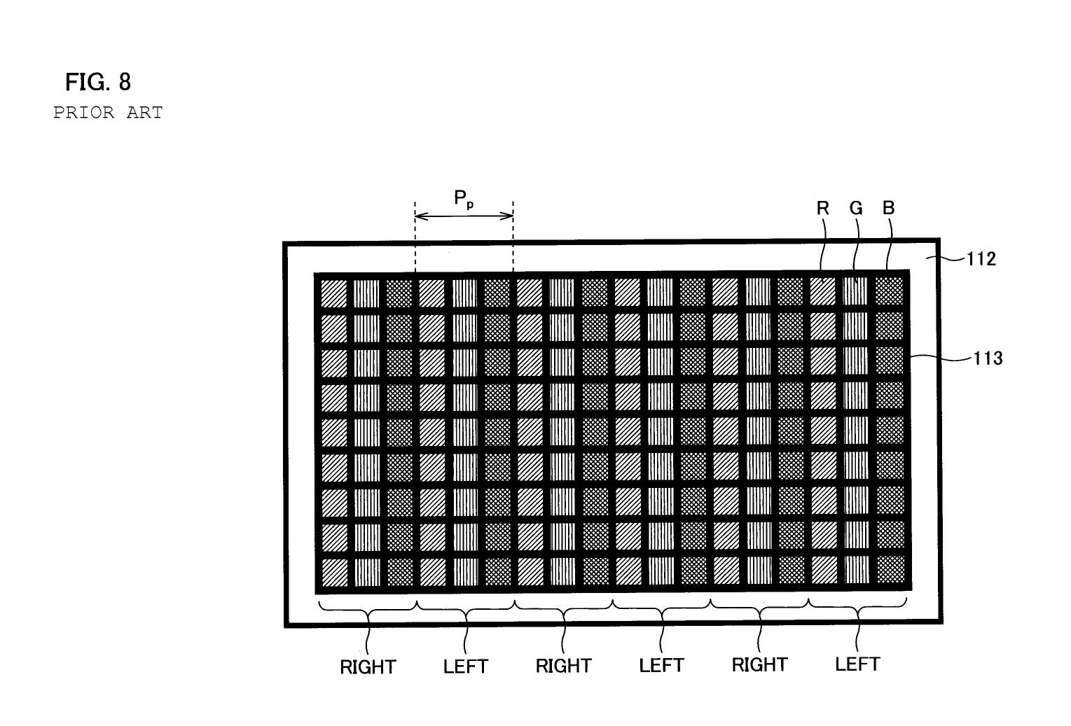

FIG. 9 is a plan view illustrating a barrier section in the conventional display device.

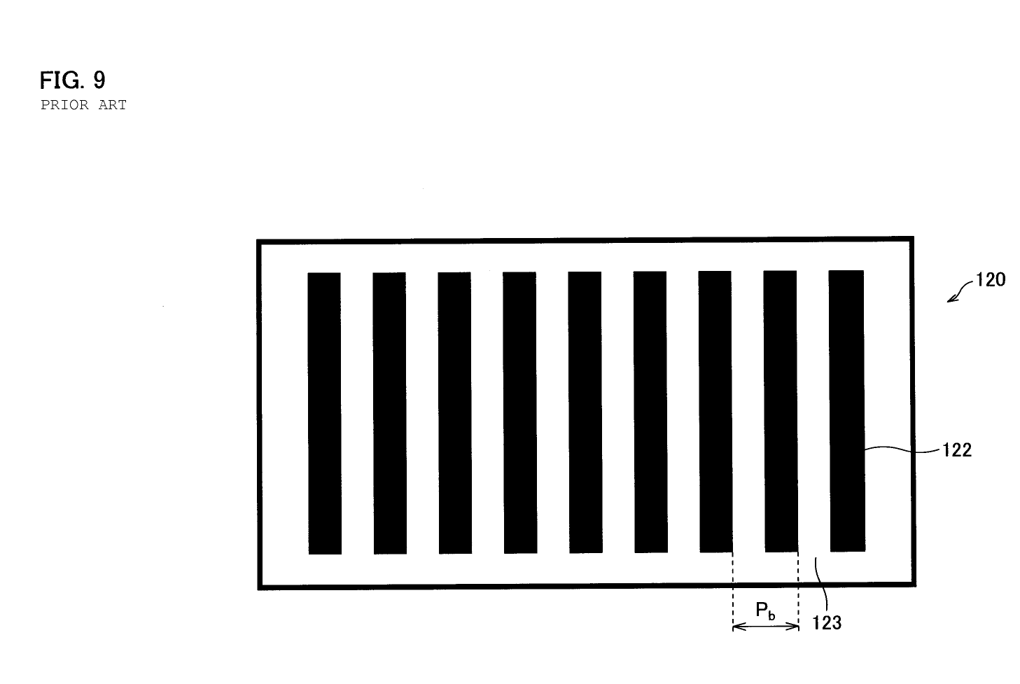

### DETAILED DESCRIPTION OF THE PREFERRED EMBODIMENTS

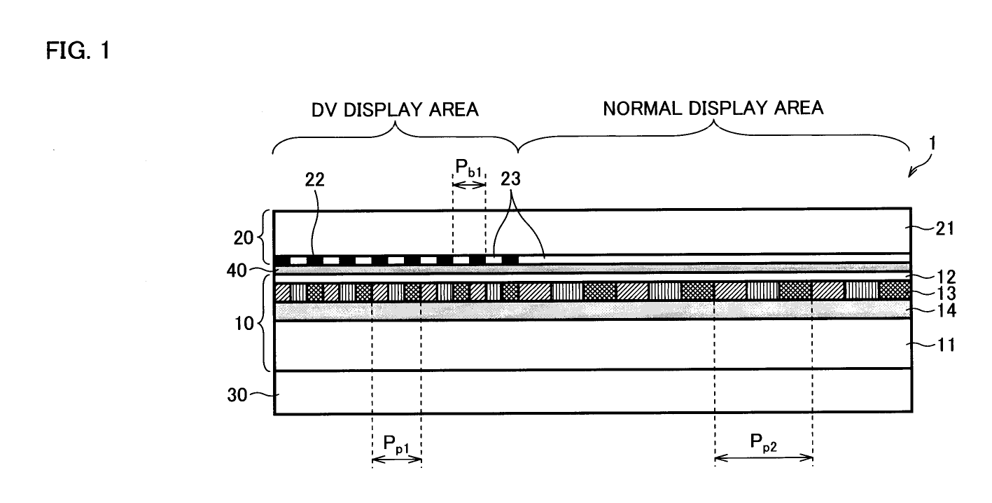

The following explains preferred embodiments of the present invention with reference to figures. FIG. 1 is a cross sectional view schematically illustrating the configuration of a display device 1 according to the present preferred embodiment.

The display device 1 includes a display screen provided with a normal display area and a DV display area (identical-location plural-image display area). The normal display area is for use in displaying an image such that it looks substantially the same when viewed in any direction. In the DV display area, different images can be displayed (DV (dual view)) in a plurality of directions respectively.

The display device 1 is preferably used, for example, as an instrument panel of an automobile (vehicle), and is configured to carry out a display operation in the following manner. That is, different images are displayed on the DV display area such that one image is observed from the driver seat side and the other image is observed from the passenger seat side. On the other hand, on the normal display area, an image of an instrument such as a speedometer can be displayed. Further, it is possible to display, on the DV display area, (i) a navigation image for the driver seat side and (ii) a television image or the like for the passenger seat. Further, the display device 1 is capable of carrying no display for the driving seat side on the DV display area but carrying out display for the passenger seat side while the vehicle is moving.

As shown in FIG. 1, the display device 1 includes a display panel 10, a barrier section 20, a backlight 30, and an adhesive resin layer 40.

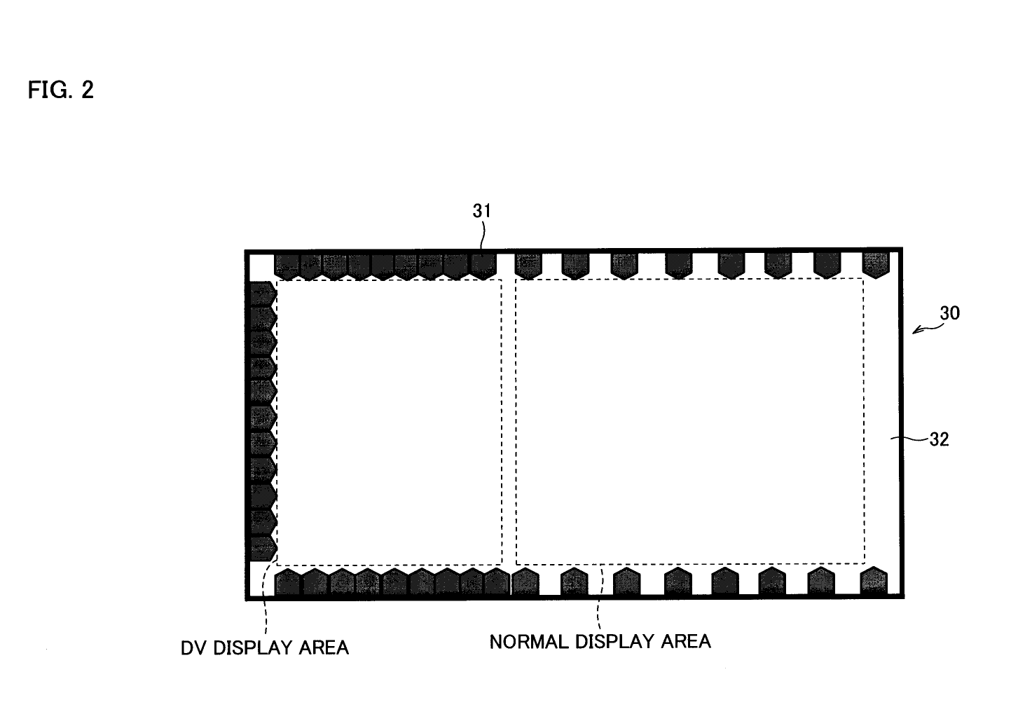

The backlight 30 emits light to the display panel 10. FIG. 2 is a plan view schematically illustrating the configuration of the backlight 30. As shown in FIG. 2, the backlight 30 includes a multiplicity of LEDs (light emitting diodes) 31 each serving as a light source, and a reflecting section 32. As shown in FIG. 2, the LEDs 31 are provided on the circumference of the reflecting section 32.

The proportions of the LEDs 31 for the display areas (the number of LEDs 31 per unit area in the display areas) are determined as follows. That is, the number of LEDs 31 for the DV display area and the number of LEDs 31 for the normal display area differ from each other such that when the same image is displayed on the DV display area and the normal display area, the display areas on the display screen have the substantially the same luminance (luminance distribution) for the observers. Specifically, in the display device 1, the ratio of the size of the DV display area to the size of the normal display area is set to be 1:1, and the ratio of the number of LEDs 31 for the normal display area to the number of LEDs 31 for the DV area is 1:3. More specifically, the display device 1 preferably is a 15-inch display device in which 90 LEDs 31 are provided for the DV display area and 30 LEDs 31 are provided for the normal area, for example. With this, when the same current is set to be supplied to each of the LEDs 31 in the display device 1, light emitted from the backlight 30 to an area located in the display panel 10 and corresponding to the DV display area has a luminance of 20000 cd/cm², and light emitted to an area corresponding to the normal display area has a luminance of 5000 cd/cm².

The display panel 10 preferably is an active matrix type liquid crystal display panel in which a liquid crystal layer 14 is interposed between a TFT substrate 11 and a CF substrate 12 provided face to face to each other.

Provided on the TFT substrate 11 are a multiplicity of data signal lines (not shown) and a multiplicity of scan signal lines (not shown) crossing with the data signal lines respectively. For combinations of these data signal lines and scan signal lines, pixels are provided respectively. Further, the data signal lines are connected to a source driver (not shown), and the scan signal lines are connected to a gate driver (not shown). Each of the source driver and the gate driver generates signals (data) for displaying images on the pixels in accordance with the display directions of the pixels. This makes it possible to independently apply the driving voltages to the pixels so as to change orientation states of liquid crystal molecules of each pixel region in the liquid crystal layer 14. In this way, a display operation is carried out. In the display device 1, the TFT substrate 11 preferably has a thickness of 700 μm, for example.

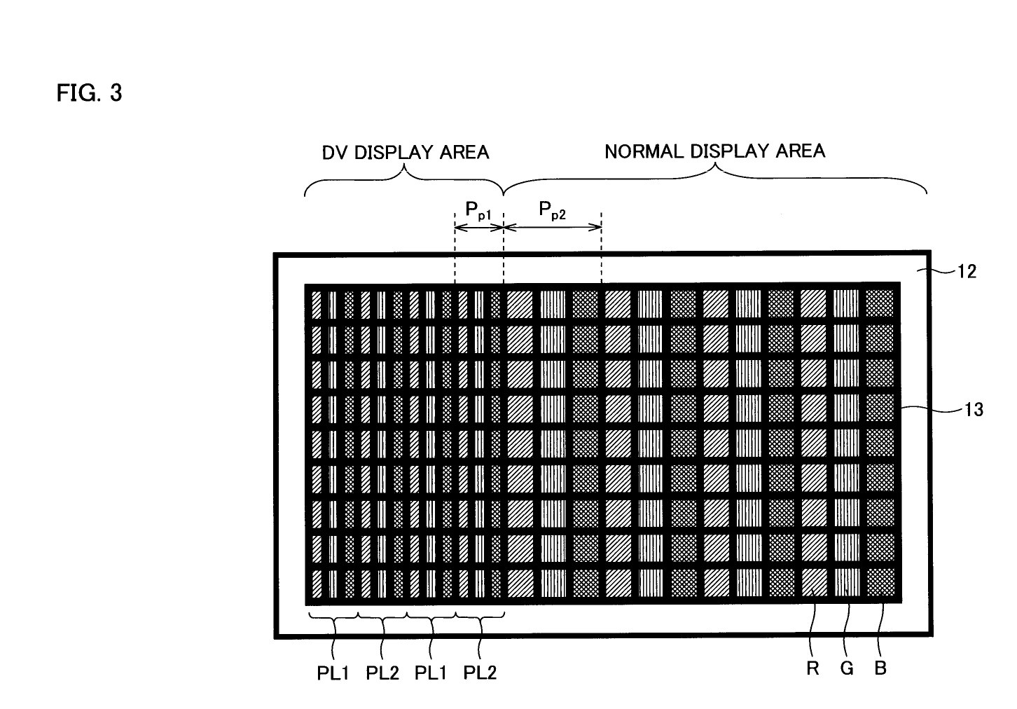

The CF (color filter) substrate 12 includes a color filter layer 13. The CF substrate 12 is thin as a result of a chemical etching process or a mechanical process such as grinding, and has a thickness of 50 μm. FIG. 3 is a plan view schematically illustrating the configuration of the CF substrate 12. As shown in FIG. 3, the color filter layer 13 is provided on the CF substrate 12, and includes sub pixels of colors of R (red), G (green), and B (blue) for each pixel.

In the DV display area, lines of pixels in the vertical direction, i.e., pixel columns are provided such that pixel columns PL1 for the driver seat side (for display for the driver seat side) and the pixel columns PL2 for the passenger seat side (for display for the passenger seat) alternate with each other in the horizontal direction of FIG. 3. In other words, the pixel columns for displaying images on the DV display area are provided in a fixed order in accordance with the respective directions in which the images are to be displayed. Further, a driving voltage is applied (data is supplied) to each of the pixel columns in the DV display area such that images are displayed so as to correspond to their display directions respectively. On the other hand, a driving voltage is applied (data is supplied) to each of the pixel columns in the normal display area such that one image is displayed in every display direction.

Further, in the display device 1, a horizontal pitch of the sub pixels in the pixel columns for displaying images on the DV display area is different from that in the pixel columns for displaying an image on the normal display area. Specifically and preferably, each sub pixel in the pixel columns for displaying images on the DV display area has a pitch of 32.50 μm, whereas each sub pixel in the pixel columns for displaying an image on the normal display area has a pitch of 65.00 μm, for example. Accordingly, a horizontal pixel pitch (pixel column pitch) Pₚ₁ in the DV display area is: Pₚ₁=32.50×3=97.5 μm. On the other hand, a horizontal pixel pitch (pixel column pitch) Pₚ₂ in the normal display area is: Pₚ₂=65.00×3=195 μm. Namely, the horizontal pitch Pₚ₁ in the DV display area is half of the horizontal pitch Pₚ₂ in the normal display area. In other words, the pixel density in the DV display area is twice as large as the pixel density in the normal display area.

Note that, in the display panel 10, the vertical pixel pitch in the normal display area and the vertical pixel pitch in the DV display area may be the same value.

The adhesive resin layer 40 is an adhesive layer for bonding the display panel 10 and the barrier section 20 together, and is constituted by a transparent resin having a thickness of 30 μm, for example.

The barrier section 20 is made up of a barrier glass 21, barrier light shielding layers 22, and a resin layer 23. The barrier light shielding layers 22 shield a part of light emitted from the backlight 30 and having passed through the DV display area of the display panel 10. The resin layer 23 is provided on the barrier glass 21 so as to surround the barrier light shielding layers 22 such that a plane formed above the barrier glass 21 becomes flat. The resin layer 23 thus formed on the barrier glass 21 has a thickness of 40 μm, for example.

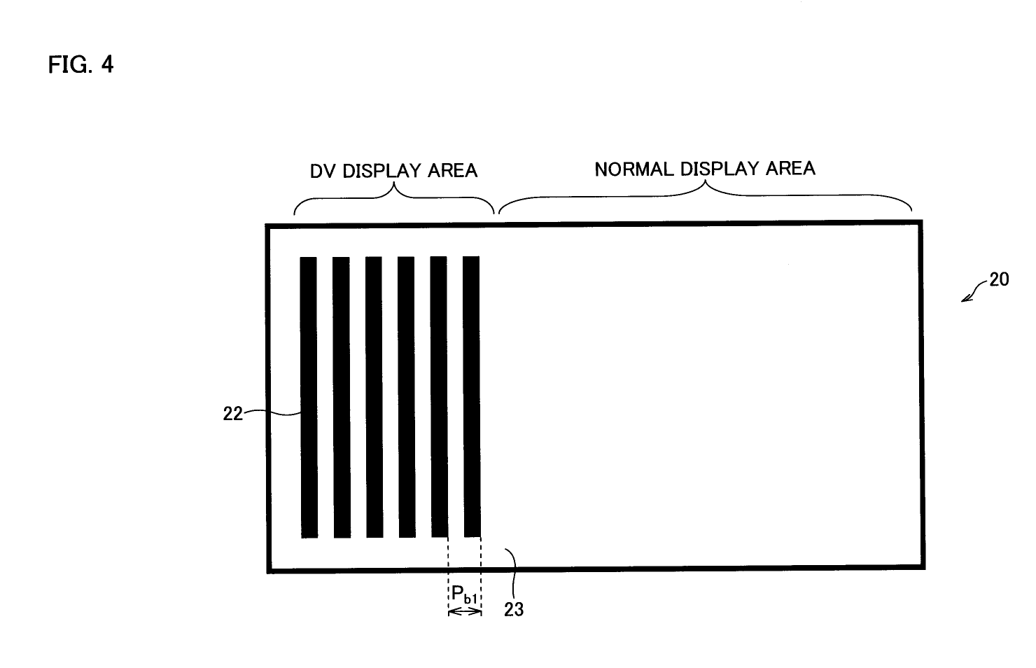

FIG. 4 is a plan view schematically illustrating the configuration of the barrier section 20. As shown in FIG. 4, the barrier light shielding layers 22 are provided in the form of stripes, i.e., in the form of lines extending in the vertical direction, within an area located on the surface of barrier section 20 and corresponding to the DV display area. Although the barrier light shielding layers 22 are formed in the area corresponding to the DV display area as such, the barrier light shielding layers 22 are not formed in an area corresponding to the normal display area. Further, the barrier light shielding layers 22 are provided at a pitch (barrier pitch) P_{b1} of 64.99 μm, for example.

Further, the barrier light shielding layers 22 are provided so as to correspond to the pixel columns in the DV display area, respectively. That is, the barrier light shielding layers 22 are provided so as to shield a part of light coming via the pixel columns PL1 and PL2 in the DV display area such that the images corresponding to the pixel columns are not observed in directions other than their display directions respectively. Hence, the image corresponding to the pixel columns PL 1 for the driver seat side can be observed from the driver seat side, but cannot be observed from the passenger seat side. Likewise, the image corresponding to the pixel columns PL2 for the passenger seat side can be observed from the passenger seat side but cannot be observed from the driver seat side. As such, the display device 1 is capable of displaying, on the DV display area, the different images for the driver seat side and the passenger seat side respectively.

As described above, the display device 1 includes the display screen provided with (i) the normal display area for normal display, i.e., for displaying an image such that it looks substantially the same when viewed in any direction, and (ii) the DV display area for displaying different images in a plurality of directions respectively.

As such, the image that is supposed to look the same (substantially the same) when viewed in any direction is displayed on the normal display area, so that high quality display (high resolution display) can be attained as compared with a case where the conventional DV display use display device whose entire display screen serves as a DV display area displays, on a part of the DV display area, one image in every direction.

Further, in the display device 1, the luminance of the light emitted from the backlight 30 to the normal display area and the luminance of the light emitted to the DV display area are different from each other. Specifically speaking, the luminance of the light emitted from the backlight 30 to the DV display area is larger than the luminance of the light emitted from the backlight 30 to the normal display area. With this, visibility in the DV display area becomes close to visibility in the normal display area.

Further, in the display device 1, the luminances of the light emitted from the backlight 30 to the respective display areas are set such that the luminances in the DV display area and the normal display area within the display screen are substantially the same for an observer when the same image is displayed on the DV display area and the normal display area.

With this, the visibility in the DV display area and the visibility in the normal display area become substantially the same. This allows the observer to observe the entire display screen without feeling strange. For example, even in cases where one image is displayed fully on the display screen including the normal display area and the DV display area, the observer is allowed to observe the image without feeling strange.

Further, in the display device 1, the ratio of the number of the LEDs 31 for the DV display area to the number of the LEDs 31 for the normal display area is 1:3; however, the numbers of the LEDs 31 in the display areas are not limited to the above. When the proportion of the LEDs 31 for the DV display area (the number of LEDs 31 per unit area) is larger than the proportion of the LEDs 31 for the normal display area, the visibilities in both display areas are close to each other.

Note that the luminance of the light entering each of the display areas of the display panel 10 is in reverse proportion to the size of the display area, and is in proportion to the number of the LEDs 31 for the display area. In other words, the luminance of the light is in proportion to the proportion of LEDs provided therefor. Hence, the proportion (or the number) of the LEDs 31 provided for each of the display areas may be set arbitrarily according to the size of the display area and brightness required for the incoming light to the display area.

For example, the number of LEDs 31 in each of the display areas may be set according to the size of the display area such that visibility in the entire display screen is substantially uniform.

Further, in the above explanation, the respective proportions of the LEDs 31 provided for the display areas preferably are different; however, the present invention is not limited to this. For example, the proportions of the LEDs 31 for the normal display area and the DV display area may be set to be the same and a current supplied to the LEDs 31 for the normal display area and a current supplied to the LEDs 31 for the DV display area may be set to be different from each other, with the result that the luminance of the light irradiated on the normal display area and the luminance of the light irradiated on the DV display area differ. A specific example of this is as follows. In the display device 1, the respective proportions of the LEDs 31 for the display areas are caused to be the same, a current of 7 mA is set to be supplied to the LEDs 31 for irradiating light to the normal display area, and a current of 21 mA is set to be supplied to the LEDs 31 for irradiating light to the DV display area. With this, the luminances of the light irradiated on the display areas respectively are the same as those in the case where the ratio of the numbers of the LEDs 31 for the display areas is 3:1. Note that both the proportions of the LEDs 31 in the display areas and the currents to be supplied to the display areas may be set to differ based on the display areas.

Further, the display device 1 may be arranged such that luminance for an image displayed on the normal display area and luminance for an image displayed on the DV display area are changeable arbitrarily. In this case, the luminance for the image displayed on the normal display area and the luminance for the image displayed on the DV display area may be adjustable, individually.

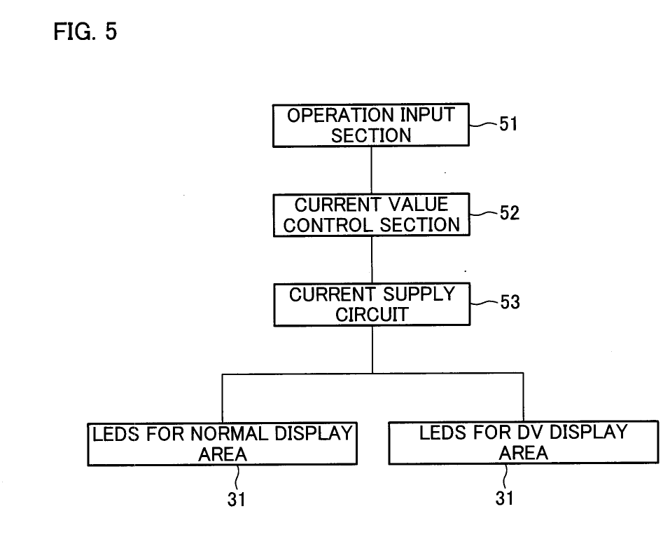

FIG. 5 is a block diagram illustrating an exemplified configuration for controlling the luminances for the images respectively displayed on the display areas, in response to an instruction inputted from an observer. In this case, as shown in FIG. 5, the display device 1 includes an operation input section 51, a current value control section 52, and a current supply circuit 53.

The operation input section 51 is an interface for receiving an instruction from the observer and transmits the observer's instruction to the current value control section 52. The configuration of the operation input section 51 is not particularly limited. For example, the operation input section 51 may be constituted by buttons and rotary knobs via which the observer inputs the instruction. Alternatively, the operation input section may be a remote controller via which the instruction is inputted using a radio signal.

The current supply circuit 53 supplies a current for causing each LED 31 to emit light. The value of the current to be supplied is variable for each display area.

The current value control section 52 controls the current supply circuit 53 so as to set the value of the current to be supplied to each of the LEDs for the display areas, for the sake of realizing the luminance corresponding to the instruction inputted via the operation input section 51.

The display device 1 thus configured allows the observer to arbitrarily set the luminances for the images displayed on the display areas, respectively. Thus, the observer is allowed to adjust the luminance for each of the images displayed on the display areas, in accordance with, e.g., a type of image displayed thereon and use thereof.

Further, the display device 1 preferably uses each LED as a light source; however, the present invention is not limited to this. However, the use of the LEDs makes it possible to easily control the luminance of the light emitted from the backlight 30 to each of the display areas, by controlling the respective proportions of the LEDs provided for the display areas or an amount of a current to be supplied to each of the LEDs. The use of the LEDs also makes it possible to control the luminances for the images on the display areas easily and precisely by controlling the value of a current to be supplied to each of the LEDs.

Further, in the display device 1, the horizontal pixel pitch Pₚ₁ in the DV display area is preferably set to be half of the horizontal pixel pitch pₚ₂ in the normal display area; however, the present invention is not limited to this. The horizontal pitches may be set as follows: Pₚ₁≦Pₚ₂. With this, the display quality of the image displayed on the DV display area becomes close to the display quality of the image displayed on the normal display area.

In the DV display area, the pixel columns PL1 for the driver side and the pixel columns PL2 for the passenger seat side are provided alternately. Therefore, from either one of the driver side and the passenger seat side, it is possible to observe only half of all the pixels (resolution) in the DV display area. For example, assume that the DV display area has a resolution of 400 (vertical)×600 (horizontal). In this case, the observer views an image with a resolution of 400 (vertical)×300 (horizontal). On the other hand, in the normal display area, the observer can view a displayed image with a resolution corresponding to that of the normal display area. For example, assume that the DV display area has a resolution of 400 (vertical)×600 (horizontal). In this case, the observer is allowed to view an image with a resolution of 400 (vertical)×600 (horizontal). Accordingly, if the horizontal pixel pitch Pₚ₁ in the DV display area is the same as the pixel pitch Pₚ₂ in the normal display area, the image quality (resolution, fineness) of the image observed by the observer and displayed on the DV display area is worse than the image quality of the image in the normal display area. Especially, when one image is displayed fully on the display screen including the normal display area and the DV display area, the observer recognizes a difference in the display qualities between the display areas with ease, with the result that the observer feels strange.

In view of this, the horizontal pixel pitch Pₚ₁ in the DV display area is set to be half of the horizontal pixel pitch Pₚ₂ in the normal display area (Pₚ₁:Pₚ₂=1:2), so that the display quality in the DV display area and the display quality in the normal display area are kept to be substantially the same. In other words, from either one of the driver seat side and the passenger seat side, the image on the DV display area can be viewed with a resolution substantially the same with that of the normal display area. Hence, even in cases where, for example, one image is fully displayed on the display screen including the normal display area and the DV display area, the observer never feels strange while viewing the image displayed on the display areas.

Further, in the display device 1, the barrier pitch P_{b1} of the barrier light shielding layers 22 is shorter than the pixel pitch (CF pitch) Pₚ₁ in the DV area. This attains uniform DV display on the DV display area. Note that the barrier section 20 (barrier light shielding layers 22) may be provided in the observer side such that a distance between the barrier section 20 and the observer is shorter than a distance between the display panel 10 (pixel columns) and the observer. Alternatively, the barrier section 20 may be provided in a side opposite to the observer side, i.e., in a side in which the light source 31 is provided. However, in cases where the barrier section 20 is provided in the observer side, the pitch of the barrier light shielding layers 22 needs to be shorter than the pixel pitch Pₚ₁ for the sake of attaining uniform DV display. On the other hand, in cases where the barrier section 20 is provided in the side in which the light source 31 is provided, the pitch of the barrier light shielding layers 22 needs to be longer than the pixel pitch Pₚ₁.

Further, as described above, the display device 1 is capable of carrying out no display operation for the driver seat side on the DV display area but carrying out a display operation only for the passenger seat side while the vehicle is moving. Here, the expression “carrying out no display operation for the driver seat side” encompasses not only the case of displaying nothing thereon but also the case of carrying out substantially no display operation by, e.g., displaying thereon a monochrome image such as a black image. As such, no display operation (or substantially no display operation) is carried out for the driver seat side on the DV display area while the vehicle is moving, thereby preventing distraction of the driver's attention to his/her driving operation.

As a mechanism for detecting whether the vehicle is moving or not, the display device may include a vehicle speed sensor, a gear-shift position sensor, a sensor for detecting a state of the parking brake, or the like, and the display device may change, according to the result of the detection, contents to be displayed on the DV display area for the driver side, when the vehicle is brought to a halt state and a moving state.

Further, the present invention is not limited to such a configuration that no display operation is carried out for the driver seat side on the DV display area while the vehicle is moving. For example, the display device may be configured to display navigation information or a captured image of surroundings of the vehicle such that the navigation information or the captured image can be observed from the driver seat side while the vehicle is moving. In cases where image display during moving of a vehicle is prohibited by a law, an ordinance, or the like, compliance with these regulations should precede this configuration. Further, in cases where such a display operation is carried out for the driver seat side on the DV display area while the vehicle is moving, it is necessary to avoid displaying information that distracts the driver's attention and therefore lowers safety in driving.

Further, the display device 1 preferably uses a liquid crystal display panel as the display panel 10; however, the present invention is not limited to this. Usable as the display panel 10 are, e.g., an organic EL (Electro Luminescence) panel, a plasma display panel, a CRT (Cathode Ray Tube), and the like.

Further, the present preferred embodiment deals with the case where the display device 1 is preferably used as an instrument panel of an automobile; however, the use of the display device of the present invention is not limited to this. For example, instead of the instrument panel, the display device may be used as a display device built in a vehicle and used to display a navigation image, a television image, and the like. Moreover, the display device is not limited to such a display device built in a vehicle, but is widely usable for (i) a display device such as a television or a monitor, (ii) an OA (Office Automation) instrument such as a word processor or a personal computer, (iii) a display device provided in a video camera, a digital camera, or an information terminal such as a mobile phone, and (iv) the like.

Further, in the present preferred embodiment, the respective specific dimensions of the sections of the display device 1 are examples only. These specific dimensions are not to limiting of the present invention, and may be arbitrarily set according to usage, etc., of the display device.

In the display device 1, one DV display area and one normal display area are preferably provided within the display screen; however, the present invention is not limited to this. For example, the display device 1 may be configured such that there are provided a plurality of DV display areas and/or normal display areas within the display screen and different images are formed on the display areas respectively.

Further, the display device 1 is configured to display different images on the DV display area preferably in the two directions, i.e., toward the driver seat side and the passenger seat side, respectively; however, the present invention is not limited to this. The display device 1 may be configured to display thereon different images in three or more directions respectively.

Further, in the present preferred embodiment, an image that is supposed to look substantially the same when viewed in any direction is displayed on the normal display area. Here, the wording “image that is supposed to look substantially the same” refers to an “image presenting the same image information in every display direction”. An example of this is as follows. That is, in cases where a liquid crystal display panel is employed, the luminance, etc., for the image is likely to differ due to a viewing angle property of the liquid crystal display panel when viewed in different display directions. Such a difference is the case of “substantially the same”.

The display device according to various preferred embodiments of the present invention may further include a multiplicity of pixel columns for displaying an image on each of the display areas, among the multiplicity of pixel columns, pixel columns for displaying images on the identical-location plural-image display area being provided in a fixed order in accordance with display directions of the images such that the images are displayed in the display directions specific to the pixel columns when each of the pixel columns is fed with a driving voltage, pixel columns for displaying an image on the normal display area being provided such that the image is displayed in every display direction when each of the pixel columns is fed with a driving voltage, the display device, further including light shielding elements arranged to shield light, coming via the pixel columns for displaying the images on the identical-location plural-image display area, such that the images are not be able to be observed in directions other than the display directions corresponding to the pixel columns, respectively.

According to the above configuration, different images can be displayed on the identical-location plural-image display area in the plurality of display directions respectively, and one image can be displayed on the normal display area in substantially the same way for the display directions.

Further, the display device according to a preferred embodiment of the present invention may further include: a light source arranged to supply light for use in display on the identical-location plural-image display area and the normal display area, wherein: the light source supplies, to the identical-location plural-image display area, light having a luminance larger than a luminance of light supplied from the light source to the normal display area.

The pixel columns for displaying the images on the identical-location plural-image display area are provided in the fixed order in accordance with the directions in which the images are displayed. Further, in the identical-location plural-image display area, the light shielding element shields light having come from the pixel columns and going in directions other than the display directions corresponding to the pixel columns. Accordingly, if the respective luminances of the light supplied from the light source to the display areas are the same, it is observed that brightness in the identical-location plural-image display area is darker than brightness in the normal display area in the display screen. In view of this, the luminance of the light to be supplied from the light source to the identical-location plural-image display area is set to be larger than the luminance of the light to be supplied to the normal display area, with the result that the luminance in the identical-location plural-image display area comes close to the luminance in the normal display area within the display screen observed by the observer. In this way, a difference between visibility in the normal display area and visibility in the identical-location plural-image display area becomes small, so that the observer never feels strange while observing the entire display screen.

The luminance of the light supplied from the light source to the identical-location plural-image display area and the luminance of the light supplied from the light source to the normal display area may be set such that in cases where an identical image is displayed on the normal display area and the identical-location plural-image display area, luminances in the display areas are set to be substantially identical in the display screen observed.

By thus setting the luminances of the light to be supplied from the light source to the display areas, it is possible to realize substantially the same visibility in the identical-location plural-image display area and the normal display area.

The display device may be configured such that: light emitting diodes are used as the light source, and a proportion of light emitting diodes provided to supply the light to the identical-location plural-image display area, and a proportion of light emitting diodes provided to supply the light to the normal display area are different from each other.

In cases where the light emitting diodes are used as the light source, the luminance of the light irradiated from the light source to each of the display areas is in proportion to the proportion of the light emitting diodes provided for the display area. In view of this, the proportions of the light emitting diodes for supplying the light to the display areas are set to be different, with the result that the luminances of the light supplied from the light source to the display areas are different.

Further, it is preferable that the proportion of the light emitting diodes provided to supply the light to the identical-location plural-image display area be more than the proportion of the light emitting diodes provided to supply the light to the normal display area. According to the above configuration, the visibility in the identical-location plural-image display area comes close to the visibility in the normal display area.

Further, the display device may be configured such that: light emitting diodes are used as the light source, and a value of a current supplied to light emitting diodes for supplying the light to the identical-location plural-image display area, and a value of a current supplied to light emitting diodes for supplying the light to the normal display area are different from each other.

In cases where the light emitting diodes are used as the light source, the luminance of the light emitted from each light emitting diode is in proportion to the value of a current supplied to the light emitting diode. In view of this, the value of a current to be supplied to each of the light emitting diodes for supplying light to the normal display area and the value of currents to be supplied to the light emitting diodes for supplying light to the identical-location plural-image display area are set to be different, with the result that the respective luminances of the light supplied from the light source to the display areas become different from each other.

Further, it is preferable that the value of the current supplied to each of the light emitting diodes for supplying the light to the identical-location plural-image display area be larger than the value of the current supplied to each of the light emitting diodes for supplying the light to the normal display area. According to the above configuration, the visibility in the identical-location plural-image display area comes close to the visibility in the normal display area.

Further, the display device may further include: a light source, which supplies, to the identical-location plural-image display area and the normal display area, light for use in display and is capable of varying a luminance of the light; an input device arranged to receive an instruction input regarding luminances for the images displayed on the identical-location plural-image display area and the normal display area; and a controller arranged to control, in accordance with the input to the input device, the luminance of the light supplied from the light source to each of the display areas.

According to the above configuration, the luminances in the normal display area and the identical-location plural-image display area within the display screen observed by the observer can be adjusted individually in accordance with the instruction inputted via the input device. This allows the observer to adjust brightness in each of the display areas in accordance with, e.g., a type, usage, etc., of an image to be displayed on each of the display areas.

The display device may be configured such that: light emitting diodes are used as the light source, and the controller changes a value of a current to be supplied to each of the light emitting diodes, so as to control the luminance of the light to be supplied to each of the display areas.

In cases where the light emitting diodes are used as the light source, the luminance of light emitted from each light emitting diode is in proportion to the value of a current supplied to the light emitting diode. In view of this, the value of a current to be supplied to each of the light emitting diodes for supplying the light to each of the display areas is set to be changed, with the result that it is possible to easily control the luminances in the normal display area and the identical-location plural-image display area within the display screen observed by the observer.

The display device may be configured such that: a pitch of the pixel columns for displaying the images on the identical-location plural-image display area is not more than a pitch of the pixel columns for displaying the image on the normal display area.

The pixel columns for displaying the images on the identical-location plural-image display area are formed in the fixed order in accordance with the display directions of the images. Further, the light shielding element shields a part of the light emitted from the pixel columns for displaying the images on the identical-location plural-image display area, with the result that the images cannot observed from a direction other than the display directions corresponding to the pixel columns. Accordingly, from the observer side, it is possible to observe only a part of all the pixel columns for displaying the images on the identical-location plural-image display area, i.e., only pixel columns for displaying an image in the direction of the observer. If the pitch of the pixel columns for displaying the images on the identical-location plural-image display area is identical to the pitch of the pixel columns for displaying the image on the normal display area in this case for example, the number of pixel columns observed by the observer and provided in the identical-location plural-image display area is smaller than the number of pixel columns observed by the observer and provided in the normal display area. This results in deterioration of quality of an image observed by the observer and displayed on the identical-location plural-image display area, as compared with that in the normal display area.

In contrast, according to the above configuration, the pitch of the pixel columns for displaying the images on the identical-location plural-image display area is not more than the pitch of the pixel columns for displaying the image on the normal display area. In other words, the density of pixels for displaying the images on the identical-location plural-image display area is larger than the density of pixels for displaying the image on the normal display area. With this, the image quality in the identical-location plural-image display area comes close to the image quality in the normal display area.

The display device may be configured such that: the pixel columns for displaying the images on the identical-location plural-image display area are provided such that different images are displayed in two directions respectively, and the pitch of the pixel columns for displaying the images on the identical-location plural-image display area is half of the pitch of the pixel columns for displaying the image on the normal display area.

In cases where the pixel columns for displaying images on the identical-location plural-image display area are arranged such that different images are displayed thereon in two directions respectively, the number of pixel columns observed when viewing the identical-location plural-image display area in a display direction is half of all the pixel columns for displaying images on the identical-location plural-image display area. In view of this, in the above configuration, the pitch of the pixel columns for displaying the images on the identical-location plural-image display area is half of the pitch of the pixel columns for displaying the image on the normal display area. In other words, the density of the pixels for displaying images on the identical-location plural-image display area is twice as large as the density of the pixels for displaying an image on the normal display area. With this, the display quality in the identical-location plural-image display area and the display quality in the normal display area become substantially the same.

It is preferable that the light shielding elements include light shielding layers provided in a form of stripes and in substantially parallel with a direction in which each of the pixel columns for displaying the images on the identical-location plural-image display area extends, and the light shielding layers be arranged at a pitch that is different from a pitch of the pixel columns for displaying the images on the identical-location plural-image display area.

According to the above configuration, the pitch of the light shielding layers is different from the pitch of the pixel columns, thereby allowing uniform identical-location plural-image display on the identical-location plural-image display area. Note that each of the light shielding layers may be provided in the observer side such that a distance between the light shielding layer and the observer is shorter than a distance between the pixel columns and the observer. Alternatively, the light shielding layers may be provided in the side opposite to the observer side. In cases where the light shielding layers are provided in the observer side, the pitch of the light shielding layers is caused to be shorter than the pitch of the pixel columns. On the other hand, in cases where the light shielding layers are provided in the side opposite to the observer side, the pitch of the light shielding layer is caused to be longer than the pitch of the pixel columns. This allows uniform identical-location plural-image display.

The display device according to various preferred embodiments of the present invention may be built in an automobile, and may be configured such that the pixel columns for displaying the images on the identical-location plural-image display area are provided such that different images are displayed for a driver seat side and a passenger seat side respectively.

According to the above configuration, it is possible to display different images on the identical-location plural-image display area for the driver side and the passenger seat side, respectively. For example, a television image or the like is displayed for the passenger seat side, and information necessary for driving such as an image of surroundings of the vehicle is displayed for the driver side. As an alternative example, on the identical-location plural-image display area, a television image or the like is displayed for the passenger seat side, but nothing is displayed for the driver side.

In the display device according to preferred embodiments of the present invention, a portion of the plurality of display areas provided in the display screen is the identical-location plural-image display area allowing for display of different images in a plurality of display directions respectively. An area other than the identical-location plural-image display area among the plurality of display areas is the normal display area for displaying an image such that it looks substantially the same in every display direction.

This makes it possible to carry out high quality display as compared with a case where one image is displayed for every direction in a portion of the display screen provided in the conventional DV display use display device and constituted only by the identical-location plural-image display area.

The preferred embodiments and specific examples of implementation discussed in the foregoing detailed explanation serve solely to illustrate the technical details of the present invention, which should not be narrowly interpreted within the limits of such preferred embodiments and specific examples, but rather may be applied in many variations within the spirit of the present invention, provided such variations do not exceed the scope of the patent claims set forth below.

A display device according to preferred embodiments of the present invention is widely applicable to a display device built in a transportation device such as a vehicle; a display device such as a television or a monitor; a display device provided in an OA (Office Automation) instrument such as a word processor or a personal computer, a video camera, a digital camera, or an information terminal such as a mobile phone; and the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-14. (canceled)

15. A display device, comprising a display screen provided with a plurality of display areas on which different images are able to be displayed;
a portion of the plurality of display areas being an identical-location plural-image display area on which different images are able to be displayed in a plurality of display directions, respectively; and
among the plurality of display areas, a display area other than the identical-location plural-image display area being a normal display area for displaying an image such that the image looks substantially same when viewed in every display direction.

16. The display device as set forth in claim 15, further comprising a multiplicity of pixel columns arranged to display an image on each of the display areas;
among the multiplicity of pixel columns, pixel columns arranged to display images on the identical-location plural-image display area being provided in a fixed order in accordance with display directions of the images such that the images are displayed in the display directions specific to the pixel columns when each of the pixel columns is fed with a driving voltage;
pixel columns arranged to display an image on the normal display area being provided such that the image is displayed in every display direction when each of the pixel columns is fed with a driving voltage;
said display device further comprising at least one light shielding element arranged to shield light, coming via the pixel columns for displaying the images on the identical-location plural-image display area, such that the images are not be able to be observed in directions other than the display directions corresponding to the pixel columns, respectively.

17. The display device as set forth in claim 16, further comprising:
a light source arranged to supply light for use in display on the identical-location plural-image display area and the normal display area, wherein:
the light source supplies, to the identical-location plural-image display area, light having a luminance larger than a luminance of light supplied from the light source to the normal display area.

18. The display device as set forth in claim 17, wherein:
the luminance of the light supplied from the light source to the identical-location plural-image display area and the luminance of the light supplied from the light source to the normal display area are set such that in cases where an identical image is displayed on the normal display area and the identical-location plural-image display area, luminances in the display areas are set to be substantially identical in the display screen observed.

19. The display device as set forth in claim 17, wherein:
the light source includes light emitting diodes; and
a proportion of light emitting diodes provided to supply the light to the identical-location plural-image display area, and a proportion of light emitting diodes provided to supply the light to the normal display area are different from each other.

20. The display device as set forth in claim 19, wherein:
the proportion of the light emitting diodes provided to supply the light to the identical-location plural-image display area is greater than the proportion of the light emitting diodes provided to supply the light to the normal display area.

21. The display device as set forth in claim 17, wherein:
the light source includes light emitting diodes; and
a value of a current supplied to light emitting diodes for supplying the light to the identical-location plural-image display area, and a value of a current supplied to light emitting diodes for supplying the light to the normal display area are different from each other.

22. The display device as set forth in claim 21, wherein:
the value of the current supplied to each of the light emitting diodes for supplying the light to the identical-location plural-image display area is larger than the value of the current supplied to each of the light emitting diodes for supplying the light to the normal display area.

23. The display device as set forth in claim 16, further comprising:
a light source, which supplies, to the identical-location plural-image display area and the normal display area, light for use in display and is capable of varying a luminance of the light;
an input device arranged to receive an instruction input regarding luminances for the images displayed on the identical-location plural-image display area and the normal display area; and
a controller arranged to control, in accordance with the input to the input device, the luminance of the light supplied from the light source to each of the display areas.

24. The display device as set forth in claim 23, wherein:
the light source includes light emitting diodes; and
the controller changes a value of a current to be supplied to each of the light emitting diodes, so as to control the luminance of the light to be supplied to each of the display areas.

25. The display device as set forth in claim 16, wherein:
a pitch of the pixel columns for displaying the images on the identical-location plural-image display area is not more than a pitch of the pixel columns for displaying the image on the normal display area.

26. The display device as set forth in claim 25, wherein:
the pixel columns for displaying the images on the identical-location plural-image display area are arranged such that different images are displayed in two directions, respectively, and
the pitch of the pixel columns for displaying the images on the identical-location plural-image display area is half of the pitch of the pixel columns for displaying the image on the normal display area.

27. The display device as set forth in claim 16, wherein:
the at least one light shielding element includes light shielding layers provided in a form of stripes and arranged substantially parallel with a direction in which each of the pixel columns for displaying the images on the identical-location plural-image display area extends,
the light shielding layers are arranged at a pitch that is shorter than a pitch of the pixel columns for displaying the images on a dual view display area.

28. The display device as set forth in claim 15, said display device is provided in an automobile; and
the pixel columns for displaying the images on the identical-location plural-image display area are arranged such that different images are displayed for a driver seat side and a passenger seat side, respectively.
